(19) United States
(12) Patent Application Publication
(10) Pub. No.: US 2020/0323292 A1
(43) Pub. Date: Oct. 15, 2020

(54) FACIAL MASK AND THE METHOD OF FORMING THE SAME

(71) Applicant: Zeppelin Corporation, Apia (WS)

(72) Inventor: Kuo-Ching Chiang, New Taipei (TW)

(21) Appl. No.: 16/714,695

(22) Filed: Dec. 14, 2019

(30) Foreign Application Priority Data
Apr. 12, 2019 (TW) 108113131
Dec. 10, 2019 (TW) 108145156

(51) Int. Cl. A41D 13/11; A01N 25/34; A01N 59/06; A01N 29/00

(52) U.S. Cl. CPC A41D 13/11; A01N 29/00; A01N 59/06; A01N 25/34

(57) ABSTRACT

A substrate for a facial mask is provided, and the substrate is formed by a roll to roll process and to have anti-Virus function. The mask comprises an inner layer, a middle layer and an outer layer, wherein the inner layer or the outer layer comprises a cation metal-organic compound for inhibiting the virus. The cation metal-organic compound comprises a compound of synthesizing acylpyrazolone and Ni⁺, Cu²⁺, Co²⁺ or Zn²⁺, or a compound of synthesizing tetrathiosemicarbazone, two thiosemicarbazones and Ni⁺, Cu²⁺ or Zn²⁺.

### CROSS-REFERENCE TO RELATED APPLICATIONS

The present application is based on, and claims priority from, Taiwan Patent Application Serial Number 108113131 and 108145156, which were filed on Apr. 12, 2019 and Dec. 10, 2019 respectively, the disclosure of which were hereby incorporated by reference herein in their entirety.

### TECHNICAL FIELD

The present invention relates to a mask, and particularly to a facial mask with anti-Virus function.

### BACKGROUND OF RELATED ARTS

There are a variety of masks. Generally, a mask includes an outer layer, a filtering layer and an inner layer. The conventional outer layer only functions as a layer to cover the filtering layer. However, such traditional mask cannot resist UV radiation. In recent years, due to the prevalence of influenza, especially for children, the impact is particularly serious. At present, all masks on the market only have the function of filtering dust or bacteria, without the function of protecting, suppressing and eliminating viruses. Therefore, there is a need for a solution to solve the aforementioned problems.

### SUMMARY

The invention relates to a mask having the following characteristics. The invention provides a method for making a mask, which includes: preparing an immersion solution, wherein the immersion solution comprises an antiviral agent (and/or sterilizing enzyme) and a resin component; driving the base material to move by a roll to roll device, and making the base material absorb the immersion solution through an immersion tank with the immersion solution to form an antiviral agent (component) on the base material, wherein the base material comprises a non-woven fabric, PP.

The invention provides a mask including an inner layer, a middle layer arranged on the inner layer and an outer arranged on the middle layer, the method for making the mask includes steps of: preparing an immersion solution, wherein the immersion solution includes an antiviral agent (and/or sterilizing enzyme) and a resin component; driving the base material to move by a roll to roll device, and making the base material absorb the immersion solution through an immersion tank with the immersion solution to form an antiviral agent (component) on the base material, wherein the base material comprises a non-woven fabric, PP.

The invention discloses a mask including an inner layer, wherein a method of making the inner layer include: preparing an immersion solution with fragrance molecules; driving a base material to move by a roll to roll device, making the base material absorb the fragrance molecules by an immersion tank with the immersion solution, so that the base material has fragrance; a middle layer arranged on the inner layer; and an outer layer arranged on the middle layer.

A mask includes an inner layer; a middle layer arranged on the inner layer; and an outer layer arranged on the middle layer, wherein the inner layer includes a virus inhibiting inorganic-organic complex to inhibit virus. The middle layer or the outer layer includes an organic-inorganic complex. The virus inhibiting inorganic-organic complex includes a cation metal-organic compound. The virus inhibiting inorganic-organic complex includes an inorganic cation-organic compound. The virus inhibiting inorganic-organic complex includes an organic ligand bonding a metal or metalloid to form a complex. The outer layer includes an organic ligand bonding a metal or metalloid to form a complex. The inner layer or the outer layer includes a metal crystalline aluminosilicate. The inner layer or the outer layer includes an organic ligand bonding a metal or metalloid to form a complex to inhibit virus. The inner layer or the outer layer includes an organic-inorganic compound salt. The middle layer includes a nanoporous polytetrafluoroethylene (PTFE) film.

A mask comprises an inner layer; a middle layer arranged on the inner layer; and an outer layer arranged on the middle layer, wherein the outer layer includes a virus inhibiting inorganic-organic complex to inhibit virus. The inner layer or the middle layer includes an organic-inorganic complex. The inner layer includes an organic ligand bonding a metal or metalloid to form a complex. The virus inhibiting inorganic-organic complex includes an organic ligand bonding a metal or metalloid to form a complex. The inner layer or the outer layer includes a metal crystalline aluminosilicate. The virus inhibiting inorganic-organic complex includes an inorganic cation-organic compound. The virus inhibiting inorganic-organic complex includes a cation metal-organic compound. The inner layer or the outer layer includes an organic-inorganic compound salt. The middle layer includes a nanoporous polytetrafluoroethylene (PTFE) film.

A mask comprises an inner layer; a middle layer arranged on the inner layer, having a filter layer, wherein the middle layer includes a nanoporous polytetrafluoroethylene (PTFE) film; and an outer layer arranged on the middle layer, wherein the inner layer or the outer layer includes an organic ligand bonding a metal or metalloid to form a complex to inhibit virus. The inner layer or the outer layer includes an organic-inorganic compound salt.

The inner layer, the middle layer or the outer layer includes a cation metal-organic compound to inhibit virus. The outer layer comprises an ultraviolet absorber, a photochromic dye, a resin or the combination thereof. The outer layer comprises lysozyme, and the middle layer comprises nanoporous polytetrafluoroethylene (PTFE) film.

The cation metal (inorganic cation)-organic compound includes a compound of synthesizing acylpyrazolone and Ni⁺, Cu²⁺, Co²⁺ or Zn²⁺. The cation metal (inorganic cation)-organic compound includes a compound of synthesizing tetrathiosemicarbazone, two thiosemicarbazones and Ni⁺, Cu²⁺ or Zn²⁺.

The invention discloses a mask, which includes: an inner layer; a middle layer arranged on the inner layer, wherein a manufacturing method of the middle layer includes: preparing an immersion solution with an antiviral agent (and/or sterilizing enzyme) and a resin, and the middle layer substrate is adsorbed with the antiviral agent (and/or sterilizing enzyme) by an immersion tank having the immersion solution; and an outer layer arranged on the middle layer.

A mask includes an inner layer; a middle layer arranged on the inner layer, including ultra microporous polytetrafluoroethylene (PTFE) film; and an outer layer, which can resist ultraviolet rays. The outer layer includes an ultraviolet absorber, a photochromic dye, a resin or the combination thereof.

A mask includes an inner layer which includes fragrance molecules adsorbed on the substrate of the inner layer by means of an immersion solution; a middle layer arranged on the inner layer, having an ultra microporous filtration membrane (PTFE); and an outer layer arranged on the middle layer.

A mask includes an inner layer; a middle layer arranged on the inner layer, having an antibacterial component, wherein the antibacterial component includes a lysozyme or an anti influenza agent; and an outer layer arranged on the middle layer, wherein the outer layer can resist ultraviolet rays.

A mask includes an inner layer, a middle layer arranged on the inner layer, and an outer layer arranged on the middle layer, having an antibacterial component, wherein the antibacterial component comprises a lysozyme or an anti influenza agent, wherein the middle layer comprises an ultra microporous bio-filtration membrane (PTFE).

### BRIEF DESCRIPTION OF THE DRAWINGS

For a better understanding of the present invention and to show how it may be implemented, reference will now be made to the following drawings:

FIG. 1 is a diagram of an apparatus of one embodiment of the present invention.

FIG. 2 is a diagram of an apparatus of another embodiment of the present invention.

FIG. 3 is a diagram of a mask of one embodiment of the present invention.

FIG. 4 is a testing report of Security Gateway System (SGS) for anti-H3N2 virus of the present invention.

FIG. 5 is a testing report of Security Gateway System (SGS) for anti-H1N1 virus of the present invention.

### DETAILED DESCRIPTION

Generally speaking, a mask includes at least three layers, including an inner layer, a middle layer as filter layer and an outer layer. The mask of the invention includes a base material for making an outer layer or an inner layer by using the following process, so that the mask has advantages of ultraviolet protection and/or anti-Virus function.

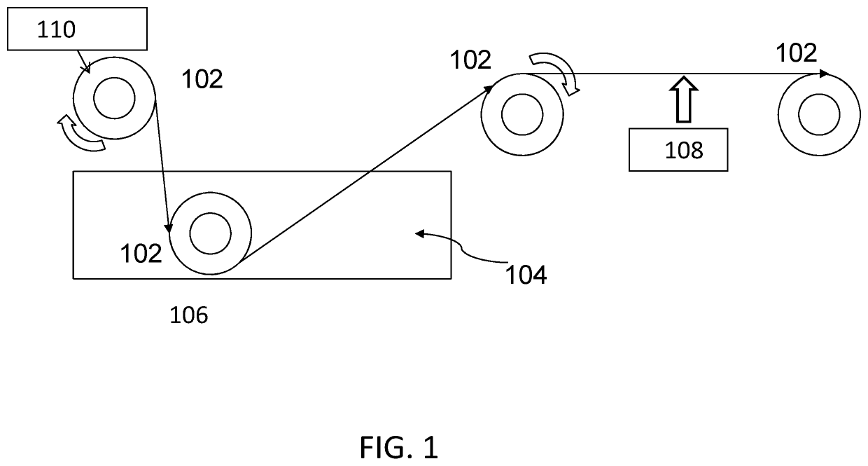

A roll to roll device 106 is configured, and the roll to roll device 106 includes at least three rotating shafts 102, wherein at least one rotating shaft is arranged in a dip dyeing tank 104 for carrying dyes. The rotating shaft 102 can be driven by a driving device, such as a motor, to rotate for a rotating axis, while moving the soft base material. For example, the base material 110 is moved by the rotating shaft 102 with the rotating direction indicated by a rotating arrow in FIG. 1 from one end to the other. In this process, the base material 110 will be driven to move, and anti-UV dyes or antiviral agents will be adhering to the base material 110 within the dip dyeing tank 104. The rotation speed of the rotating shaft 102 can be controlled to control moving speed of the base material 110, and thereby controlling the material thickness. The heating device 108 is configured under (lower side) of the horizontally moving the base material 110, and the heating device 108 can be optionally activated to provide heat source for drying. The heating device 108 may be a bulb, a heater creating hot air, electromagnetic radiation or an infrared heater.

As the process progresses, the base material is transferred from one end to the other, at which time the base material that has completed the impregnation will be rolled to the other end and collected. Based on the flexibility of the base material, it can be crimped at the other end. If necessary, the heating device can be turned on to provide heat energy for drying. Subsequently, the rolled base material can be processed into masks or other articles, such as anti-virus headgears, bedspreads, quilt covers, pillow covers, curtains, wiping towels, etc.

The non-metallic or non-metallic oxide material can be used as the anti ultraviolet material to avoid environmental pollution. By using the flexible base material, such material can pass through the rotating shaft by the roll to roll device of the invention, and the film can be manufactured in large quantities, and the process does not pollute the environment. The growth thickness of film can be controlled by the speed of driving shaft, and the film can be attached to irregular or uneven surfaces.

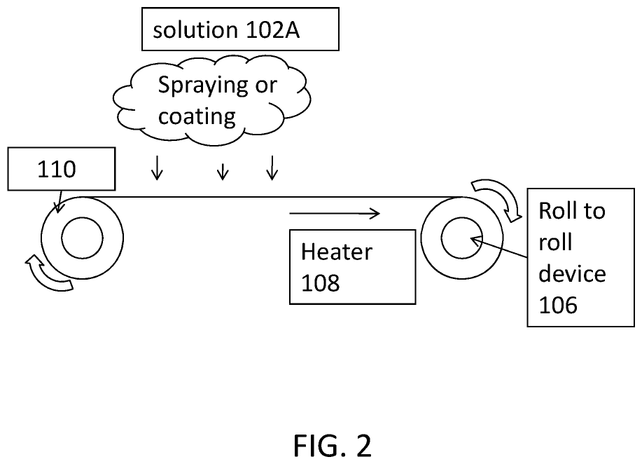

This embodiment refers to FIG. 2 which device is similar to the ones of FIG. 1, except that in this embodiment, the solution is coated on the required soft base material by printing, coating, spraying or inkjet printing. After the solution is prepared, the ink-jet, spraying, printing or coating process is started to distribute the material on the soft base. If the ink-jet printing method is used, the dye pattern can be directly sprayed on the soft base (substrate). The other methods are similar to the above embodiment, including selectively heating.

UV resistant mask can be sprayed, soaked or coated with UV resistant absorbing material or photochromic dye on the surface of the substrate to achieve the UV resistant function. If the mask has UV protection, the change can be observed, and it is known that UV protective function of the mask is absent from traditional mask, let alone its protective effect. In fact, the traditional mask has no protective function, so it is not conducive to the postoperative maintenance of facial beauty. The most important part of the beauty postoperative maintenance is to prevent ultraviolet radiation, so the invention is very important for the beauty postoperative maintenance, and the traditional mask cannot achieve this effect completely.

In the invention, the photochromic dye is mixed into resin, such as water-based resin, and the photochromic dye can be mixed with the resin in the form of micro powder, capsule state and liquid state. For example, a water-based resin is mixed with a hydrophilic photochromic dye to produce the above-mentioned dip dye solution. The mixing ratio of the photochromic dye and the resin can be 1:5-1:20, in which solvent can be used to dilute to adjust viscosity. The photochromic dye can absorb sunlight or ultraviolet light and change its chemical structure. After being irradiated by sunlight or ultraviolet light, the photochromic dye will produce reversible chemical transformation and cause color change. When not exposed to sunlight or ultraviolet rays, the original color can be restored. Photochromic dyes can be doped with photostabilizers and UV absorbers to assist UV absorption. Adding antioxidants and/or UV absorbers can improve the resistance to photofatigue.

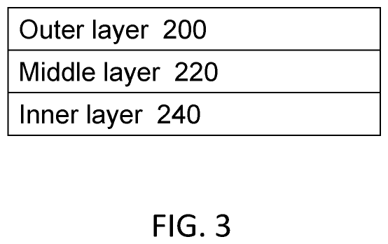

Therefore, please refer to FIG. 3, it shows the cross-sectional schematic diagram of the mask of the invention, which may include three or more layers. This embodiment takes three layers as an example. The outer layer 200 is an anti-ultraviolet layer, and its implementation can refer to the above implementation methods. The middle layer is a filter layer 220, which is used to filter dust, bacteria and so on. The inner layer 240 can be made of cotton cloth or skin friendly materials, such as ice silk cotton or TPE. Using the above method, we can make fragrance base in the inner layer. The principle is to make use of fragrance, essence, essential oil, perfume material and so on to add into the inner layer, so that we can get the fragrance inner layer and enhance the effect. The outer layer or the middle layer can be added with lysozyme or bactericidal enzyme to eliminate bacteria by spraying, dipping, coating or printing process. The traditional mask can only filter and cannot kill the virus, so the invention can not only filter, but also decompose the bacteria and inhibit the virus. In addition, the outer layer 200, inner layer 240 or the middle layer 220 can also be added with influenza virus components or bactericidal enzymes to eliminate bacteria and inhibit viruses, and the method can be spraying, dipping, coating or printing. The traditional method can only filter bacteria and cannot eliminate bacteria or virus, so the invention can not only filter, but also decompose bacteria and inhibit viruses. In addition, the antiviral agents can also be attached into the outer layer 200, the inner layer 240 or the middle layer 220 by spraying, impregnating or coating to inhibit influenza virus or enterovirus, etc. The components of inhibiting influenza virus can be cation metal-organic compounds, such as organic copper compounds, organic zinc compounds, organic tin compounds and some other cation metal-organic compounds. The both side surface of the outer layer 200, the inner layer 240 or the middle layer 220 includes the inorganic-organic complex of inhibiting influenza virus. The arrangement may eliminate the virus, bacterial from both directions, namely, from the inhale (from outside of the mask into the mask) and exhale direction (out from the mouth to the mask). Therefore, the complex on the first side (outside) of the outer layer 200, the inner layer 240 or the middle layer 220 may eliminate the virus, bacterial from outside of the mask; and the complex on the second side (inside) of the outer layer 200, the inner layer 240 or the middle layer 220 may eliminate the virus, bacterial from the mouth. In one example, one or more layers of the outer layer 200, the inner layer 240 or the middle layer 220 may include the virus inhibiting inorganic-organic complex. In order to avoid falling off as washing, the cation metal-organic compound can be added into the molten base (substrate) in the non-woven process to form non-woven fabric, so that it is not easy to lose. As the mask is a disposable commodity, it can be made by spraying, dyeing, coating or printing process. If copper (or silver) ions are used as the single deposit, it is easy to lose the inhibitory activity of bacteria due to the formation of neutral by electron capture. The above-mentioned cation metal-organic compounds can be used as organic-inorganic compound to form organic-inorganic compound salt antimicrobial agents by using antibacterial organic ligand(s) combining with antibacterial inorganic cation(s).

A virus inhibiting inorganic-organic complex (cation metal-organic (inorganic cation-organic) compounds) include metal (including metalloid) and carbon atom bonded thereto. In addition to traditional metal elements, lanthanide, actinide, semimetal or metalloid (such as boron, silicon, arsenic and selenium) can also be bonded with carbon to form cation metal-organic compounds. The cation metal-organic compound of the invention is a compound of both metal cations and organic materials, that is to say, both of them produce the cation metal-organic compound through chemical combination or reaction procedure, which belongs to the organic-inorganic combined antibacterial agent (material). For example, the synthesis of acylpyrazolone with Ni⁺, Cu²⁺, Co²⁺ or Zn²⁺ has certain inhibitory effect on Escherichia coli and Staphylococcus aureus, and the antibacterial activity of the compound is higher than that of metal ions, indicating that after the formation of the compound, the transition metal ions have enhanced the antibacterial activity of the ligand. For example, the stable chelates by synthesizing tetrathiosemicarbazone and two thiosemicarbazones with Ni⁺, Cu²⁺ or Zn²⁺ has better antibacterial ability than that of ligands and metal ions alone. Therefore, the organic-inorganic complex antibacterial agent of the invention has the advantages of individual organic and individual inorganic antibacterial agents, the high efficiency and sustainability of the organic antibacterial agent, the safety and heat resistance of the inorganic antibacterial agent, and the product has good antibacterial effect and is not interfered by the ultraviolet ray. In cation metal-organic compounds, the bond properties of metal and carbon are usually between ionic bond and covalent bond. When the electronegativity of metal is very low (such as alkali metal elements) or the ligand containing carbon is stable carbon anion, its bond will be similar to ion bond. Carbon anions can be stabilized due to resonance or the presence of electron substituent, such as triphenylmethyl anions. In another embodiment, the outer layer or the inner layer of the invention includes an alkali metal or alkaline earth metal crystalline aluminosilicate, which has a strong cation exchange capacity; metal silicates such as silver or silver and zinc silicates have good affinity with biology. The advantages still include: high safety, durability, broad-spectrum antibacterial (changing the type of metal ions, killing different strains), not easy to produce drug resistance. In the filling form, the above components are mixed with the synthetic fiber to make the fiber. Because it is mixed into the fiber, it has good washing resistance and long effect time. In the post-processing form, the above components are combined on the surface of the fiber by chemical bond or hydrogen bond, and the contact area with the virus is larger (at the same dose). It can adopt different processes for different needs.

The filter layer 220 can filter particles under 0.1-2.5 μm (micron) by using the ultra micro pore technology filtration membrane (PTFE membrane), so as to inhibit the harm of PM 2.5, prevent haze, ventilate and have good respiratory characteristics. Nanoporous polytetrafluoroethylene (PTFE) film, the pore diameter of nanoporous membrane with smaller than that of general microporous membrane, has high hydrophobicity and oil repellency, so it has extremely good moisture permeability, air permeability, water and oil repellency. The PTFE nanoporous film with ultra-high water pressure resistance and high water vapor permeability is made of ultra-high crystalline polytetrafluoroethylene, which is extruded into film under ultra-high pressure and ultra-high tensile speed such that the film has three-dimensional structure characteristics with ultra-high strength. The pore size can be controlled between 0.03 μm (30 nm) and 15 μm, the thickness is 8-50 μm, and the porosity is up to 80-97%. The ultra micro pore biological technology filtration membrane replaces the traditional non-woven filter material layer with the high polymer membrane filter material, with the filtration rate of more than 99.9%, and it can eliminate the virus, allergen and fine suspended particles in the air, with high permeability and non-tightness. The wavelength of 100-280 nm ultraviolet wave has stronger energy, and the most harmful to the skin is ultraviolet C, but most of it is isolated by the ozone layer in the atmosphere and hardly reaches the ground; and wavelength of 280-320 nm, followed by its energy, which causes skin instant sunburn, thickening of cutin, darkening, reddening, ophthalmitis and dryness, mainly caused by UVB.

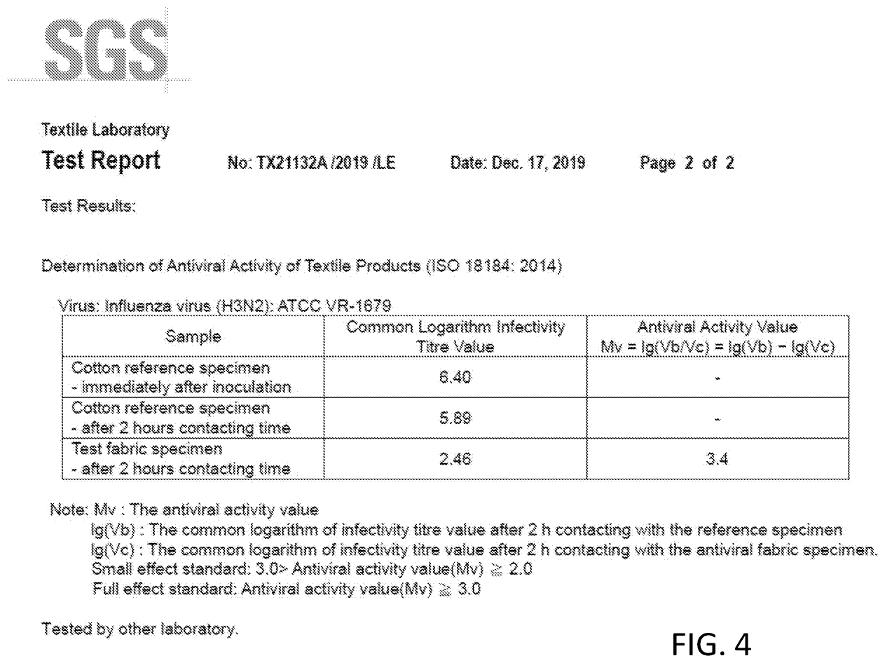

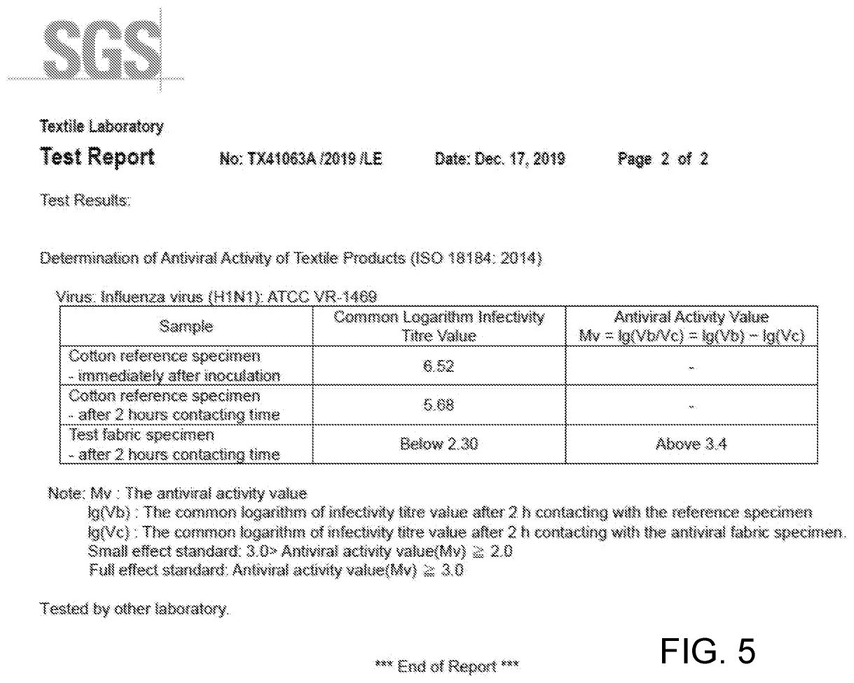

FIG. 4 and FIG. 5 show the testing reports of the mask of the invention, they indicate that the mask of the present invention has passed Security Gateway System (SGS) inspection and passed ISO (International Organization for Standardization) 18184 standards, which proves that the anti-virus effect of the invention is excellent. Please refer to FIG. 4, it states that the standard value of excellent antiviral activity is 3, while the anti-H3N2 virus activity of the invention is 3.4, which is far higher than the standard value. Please refer to FIG. 5, it indicates that the standard value of excellent antiviral activity is 3, while the anti-H1N1 virus activity of the invention is above 3.4, far higher than the standard value. The invention not only suppresses the bacteria, but also can eliminate the virus. Therefore, it can produce qualitative change, and has a new effect. From FIG. 4 and FIG. 5, they proved that the anti-virus effect of the invention is excellent (the anti-H3N2 virus activity is 3.4, the anti-H1N1 virus activity is above 3.4, which is far higher than the standard value). Therefore, the invention has quantitative changes, significant improvement in efficacy, and unexpected effect.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the present invention. It is intended that all such modifications and alterations are included insofar as they come within the scope of the present invention as claimed or the equivalents thereof.

What is claimed is:

1. A mask, comprising:
an inner layer;
a middle layer arranged on said inner layer; and
an outer layer arranged on said middle layer, wherein said inner layer includes a virus inhibiting inorganic-organic complex to inhibit virus.

2. The mask of claim 1, wherein said middle layer includes an organic-inorganic complex.

3. The mask of claim 1, wherein said outer layer includes an organic-inorganic complex.

4. The mask of claim 1, wherein said virus inhibiting inorganic-organic complex includes an organic ligand bonding a metal or metalloid to form a complex.

5. The mask of claim 1, wherein said outer layer includes an organic ligand bonding a metal or metalloid to form a complex.

6. The mask of claim 1, wherein said inner layer includes a metal crystalline aluminosilicate.

7. The mask of claim 1, wherein said outer layer includes a metal crystalline aluminosilicate.

8. The mask of claim 1, wherein said virus inhibiting inorganic-organic complex includes a cation metal-organic compound.

9. The mask of claim 1, wherein said virus inhibiting inorganic-organic complex includes an inorganic cation-organic compound.

10. The mask of claim 1, wherein said middle layer includes a nanoporous polytetrafluoroethylene (PTFE) film.

11. A mask, comprising:
an inner layer;
a middle layer arranged on said inner layer; and
an outer layer arranged on said middle layer, wherein said outer layer includes a virus inhibiting inorganic-organic complex to inhibit virus.

12. The mask of claim 11, wherein said inner layer includes an organic-inorganic complex.

13. The mask of claim 11, wherein said middle layer includes an organic-inorganic complex.

14. The mask of claim 11, wherein said inner layer includes an organic ligand bonding a metal or metalloid to form a complex.

15. The mask of claim 11, wherein said virus inhibiting inorganic-organic complex includes an organic ligand bonding a metal or metalloid to form a complex.

16. The mask of claim 11, wherein said inner layer includes a metal crystalline aluminosilicate.

17. The mask of claim 11, wherein said outer layer includes a metal crystalline aluminosilicate.

18. The mask of claim 11, wherein said virus inhibiting inorganic-organic complex includes an inorganic cation-organic compound.

19. The mask of claim 11, wherein said virus inhibiting inorganic-organic complex includes a cation metal-organic compound.

20. The mask of claim 11, wherein said middle layer includes a nanoporous polytetrafluoroethylene (PTFE) film.
